(19) United States
(12) Patent Application Publication
(10) Pub. No.: US 2012/0089604 A1
(43) Pub. Date: Apr. 12, 2012

(54) Computer-Implemented Systems And Methods For Matching Records Using Matchcodes With Scores

(76) Inventor: Jocelyn Siu Luan Hamilton, Mebane, NC (US)

(21) Appl. No.: 12/900,640

(22) Filed: Oct. 8, 2010

(51) Int. Cl. G06F 17/30

(52) U.S. Cl. 707/737; 707/E17.089

(57) ABSTRACT

Systems and methods are provided for assigning a record to one or more record clusters. A record including a plurality of fields is received. A field in the record is identified to have a likelihood of including an input error. One or more alternative fields are generated with alternative inputs. The identified field and the one or more alternative fields are compared with a plurality of record clusters to identify a cluster with a matching field. The record is assigned to the identified cluster based at least in part on the matching field.

### TECHNICAL FIELD

The present disclosure relates generally to computer-implemented systems and methods for matching records.

### BACKGROUND

A record may include data of personal names, dates, addresses and other information. Record matching is the process of bringing together two or more different records which may refer to the same real-world object. Record matching is useful in statistical surveys, administrative data development and many other areas. It is important to develop effective and efficient techniques for record matching. As humans can account for transpositions, typographical errors, abbreviations, missing data and other input errors in record matching, computer-implemented systems and methods for matching records can achieve results at least as good as a highly trained clerk.

### SUMMARY

As disclosed herein, computer-implemented systems and methods are provided for assigning a record to one or more record clusters. For example, a record including a plurality of fields is received. A field in the record is identified to have a likelihood of including an input error. One or more alternative fields are generated with alternative inputs. The identified field and the one or more alternative fields are compared with a plurality of record clusters to identify a cluster with a matching field. The record is assigned to the identified cluster based at least in part on the matching field.

As another example, a computer-implemented system and method having one or more data processors can be configured such that a record including a plurality of fields is received. Two or more fields in the record are identified to have a likelihood of being transposed. Combinations of the two or more identified fields are generated. The combinations are compared with a plurality of record clusters to identify a cluster with a matching combination. The record is assigned to the identified cluster based at least in part on the matching combination.

As another example, a computer-implemented system and method having one or more data processors can be configured such that a record including a plurality of fields is received. Two or more fields in the record are identified to have a likelihood of being transposed. Combinations of the two or more identified fields are generated. For each combination, a field in the combination is identified to have a likelihood of including a spelling error. One or more alternative fields with alternative spellings are generated. The identified field and the one or more alternative fields are compared with a plurality of record clusters to identify a cluster with a matching field. The record is assigned to the identified cluster based at least in part on the matching field.

### BRIEF DESCRIPTION OF THE DRAWINGS

FIG. 1 shows an example system for matching a record to one or more record clusters.

FIG. 2 shows an example system for matching a record to one or more record clusters based on token remapping.

FIG. 3 illustrates the configuration of an example token combination rule.

FIG. 4 illustrates the application of the example token combination rule of FIG. 3.

FIG. 5 shows an example process of applying one or more token combination rules to date records.

FIG. 6 shows a screenshot of the configuration of an example token combination rule for date records.

FIG. 7 shows a screenshot of matchcodes generated with the application of the token combination rule shown in FIG. 6 on a date record of “Feb. 1, 2010.”

FIG. 8 shows an example system for matching a record to one or more record clusters based on spellchecking.

FIG. 9 shows an example of record matching using spellchecking.

FIG. 10 shows an example system for matching a record to one or more record clusters based on token remapping and spellchecking.

FIG. 11 shows a computer-implemented environment wherein users can interact with a record matching system hosted on one or more servers through a network.

FIG. 12 shows a record matching system provided on a stand-alone computer for access by a user.

### DETAILED DESCRIPTION

In record matching, the goal is to cluster together records which, despite differences, may refer to the same real-world object. Some or all of the records within a cluster could then theoretically be replaced by a canonical record for that object which the cluster represents.

Matchcodes may be used for record matching. A matchcode is typically the text of the record, transformed by a fixed set of text-manipulating operations in order to sufficiently reduce the input text so that similar records generate the same matchcode. Table 1 shows an example of a 4-record dataset undergoing a single-matchcode generation process. Each of the records contains a personal name, including a first name token (field) and a last name token (field).

TABLE 1
Example of a Single-Matchcode Generation Process

| No. | Record | Matchcode |
|---|---|---|
| 1 | JAMES SCOTT | JAMES SKT |
| 2 | SCOTT JAMES | SCT JMS |
| 3 | SCOTT JAMAS | SCT JMS |
| 4 | SCOTT KAMAS | SCT KMA |

Because records 2 and 3 have the same matchcode, they are therefore matched and can be both assigned to a record cluster. Record 1 does not share the same matchcodes with any other record and is thus considered to not match with any other records. The same is true for record 4.

It is evident from this example that the single-matchcode method has some limitations. For example, while SCOTT JAMAS is a possible customer name, it could also, due to an input error, be a match for SCOTT JAMES or SCOTT KAMAS. Similarly, due to a transposition of tokens (fields) within a record, JAMES SCOTT and SCOTT JAMES might refer to the same person. However, the single-matchcode method generates exactly one matchcode for a record and thus cannot account for the possibility of a single record belonging to multiple record clusters. As disclosed herein, computer-implemented systems and methods are provided for matching a single record to one or more record clusters.

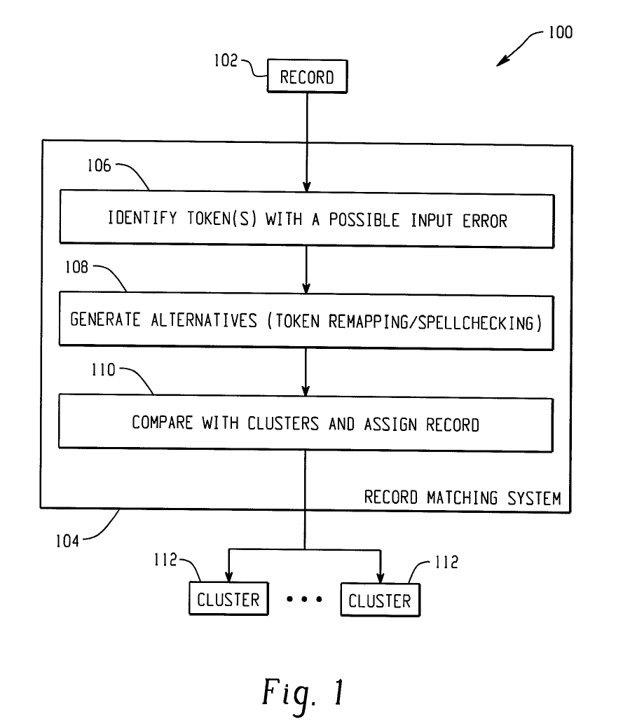

FIG. 1 shows an example system 100 for matching a record to one or more record clusters. The example system 100 includes a record matching system 104 for processing the record 102, including identifying token(s) of the record that may contain a possible input error at step 106. Alternatives of the record may be generated to address the possible input error at step 108. For example, in a personal name record, JAMAS SCOTT, it is possible that the first name token and the last name token are entered in a wrong order. An alternative of the record, SCOTT JAMAS, may be generated at step 108 to address such an input error. The record and the alternative(s) may then be compared with a plurality of record clusters at step 110. If the record or any of its alternatives match one or more record clusters, then the record may be assigned to the one or more record clusters 112. Whether the record or any of its alternatives match one or more record clusters may be determined by different approaches, for instance by using matchcodes that are generated for the record and its alternatives.

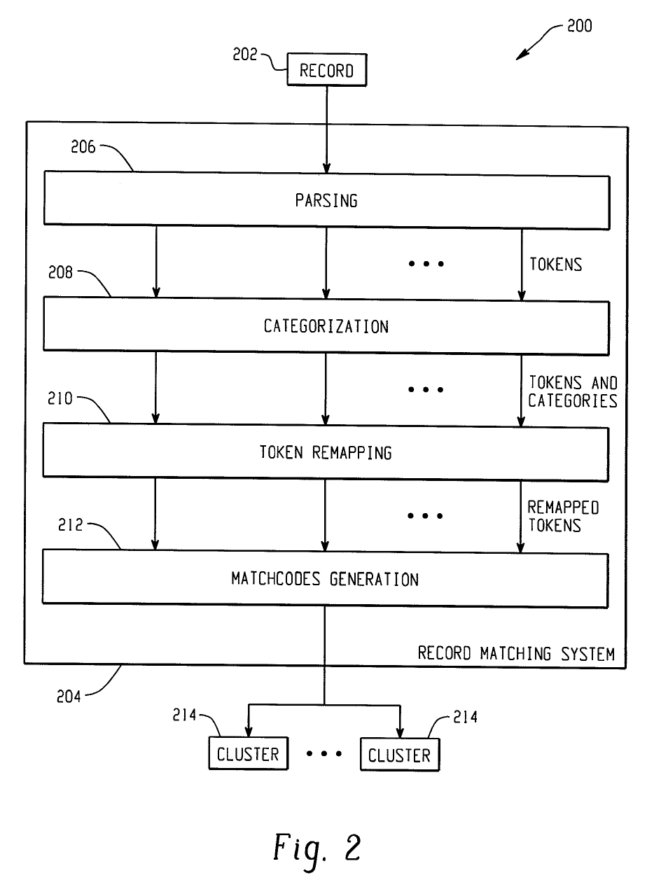

FIG. 2 shows an example system 200 for matching a record to one or more record clusters based on token remapping. The example system 200 includes a record matching system 204 for processing a record 202 based on token remapping to address possible input errors in records.

One type of input error commonly seen in matching is records that have tokens entered in different orders, or with certain tokens omitted (“token-level errors”). Some examples of these errors are shown in Table 2.

TABLE 2
Examples of token-level errors

| | | Example | Example |
|---|---|---|---|
| Type of records | Description | Record 1 | Record 2 |
| Personal names | First and | James Scott | Scott James |
| | last names | | |
| | transposed | | |
| Dates—US vs. | Day | Jan. 2, 2010 | Feb. 1, 2010 |
| Euro/Asia | and month | | |
| formats | transposed | | |
| Address | Fields | The Bell Hotel, | 24 High Street, |
| conventions | omitted | 24 High Street, | Swindon SN1 3EP |
| with redundant | | Old Town, | |
| information | | Swindon SN1 3EP | |

With reference again to FIG. 2, the record 202 is parsed into one or more tokens at step 206, if the record is not already divided into tokens. At step 208, the tokens of the record are assigned to different categories indicating a likelihood of input errors. For example, it is possible that a first name token and a last name token in a personal name record are transposed. A category COULD_BE_LAST may be assigned to the first name token and a category COULD_BE_FIRST may be assigned to the last name token.

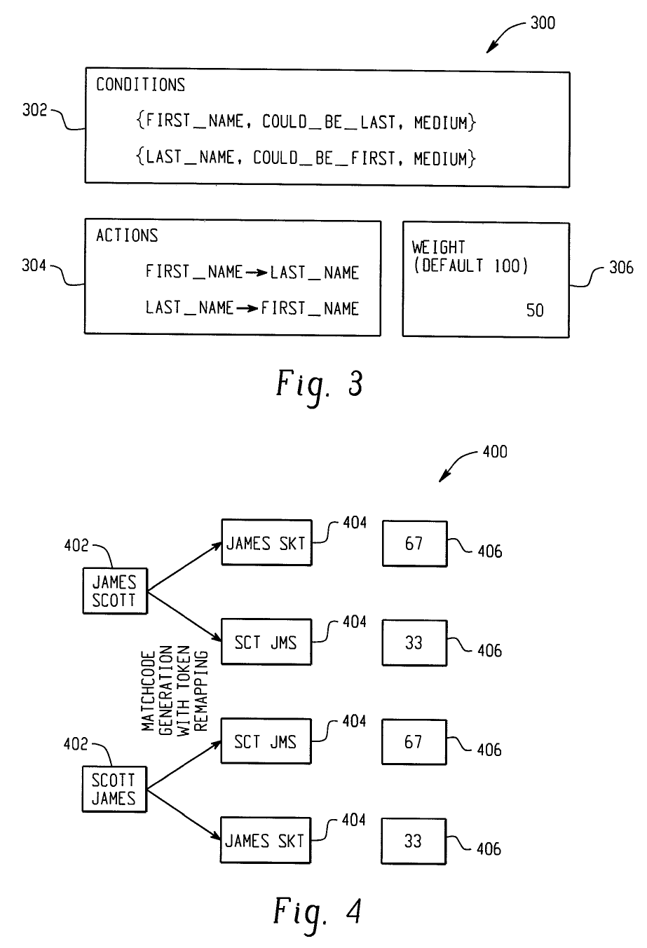

A plurality of different combinations of the tokens are then generated (token remapping) at step 210 to address the possible input errors based on the tokens' assigned categories. One combination of the tokens may keep the original form of the record. Other combinations may be generated based on one or more token combination rules. For example, for a transposition of first name and last name tokens in a personal name record, two combinations of the tokens may be generated. One combination keeps the original personal name in the record. The other combination may be generated based on a token combination rule that causes the first name token and the last name token of the record to be swapped. An example token combination rule is described below with reference to FIG. 3.

With reference again to FIG. 2, matchcodes may be generated at step 212 based on the different combinations of the tokens. For example, a matchcode may be generated for each combination of the tokens. The generated matchcodes may be used to compare with a plurality of record clusters. At step 214, the record may be assigned to every record cluster that matches with one matchcode of the record.

FIG. 3 shows the configuration 300 of an example token combination rule. The example token combination rule has three components: its conditions 302, its actions 304, and its weight 306. A condition is described by a tuple {TOKEN, CATEGORY, MIN_LIKELIHOOD}, which denotes that, in order for this condition to be satisfied, the token with name TOKEN has the category with name CATEGORY assigned to it, with a likelihood greater or equal to MIN_LIKELIHOOD. There is also an optional flag for negation. If the negation flag is specified, the logic is reversed: the token does not have CATEGORY assigned. A rule may have zero or more conditions; all the conditions for a rule may need to be satisfied in order for the rule to be applied.

An action is described by a mapping NOMINAL→REPLACEMENT, which denotes that the token with name NOMINAL is to be replaced by the token with name REPLACEMENT. The empty token (a blank string) is allowed to be specified as the replacement token in any action. The number of actions in a rule is equal to the maximum number of tokens inherent to the type of record under consideration.

The weight of a rule is a single number which reflects the importance of that rule, relative to the other token combination rules and to the “default” no-rule option that accepts the original record without changes.

Based on analysis of the tokens' assigned categories, a token combination rule's conditions are evaluated to determine if the rule is to be applied. Each applied rule results in an input-stage remapping of tokens as described by the rule's actions. A set of K rules may therefore produce a set of up to K matchcodes, in addition to the “default” matchcode produced by applying no rule at all, for a total of between 1 and K+1 matchcodes. The score assigned to each matchcode is computed using the scaled weight of the rule that produces the matchcode.

The example token combination rule shown in FIG. 3 may be used to solve a possible input error of transposed first and last names in a record. The conditions for the rule 302 may be obtained by observing that not all possible names are equally prone to transpositions. Some first names are not very commonly used as last names, and vice versa—so transposition errors may be less likely in these cases. A category is defined for first names called COULD_BE_LAST. A process is applied for determining to what degree a first name “could be” a last name (i.e. its likelihood with respect to the category COULD_BE_LAST). The process could, for example, make use of a dictionary of common first names with numeric or qualitative likelihood values. Any name encountered that is not in this dictionary could be assigned a default (e.g. low) likelihood. Likewise, for last names, a suitable category might be defined as COULD_BE_FIRST and an analogous process for determining a last name token's likelihood with respect to that category may be applied to the last name token of the record. Depending on the outcome of the token-categorization process as shown at step 208 in FIG. 2, the rule may either be applied or not applied for the record.

Finally, the weight for the rule can be obtained either empirically (say, by expert sampling of the input data to determine the frequency of transposition errors), or on the basis of a qualitative judgment of how important such transpositions are. For the example token combination rule shown in FIG. 3, the rule weight is set to 50 with the assumption that the no-rule weight is 100.

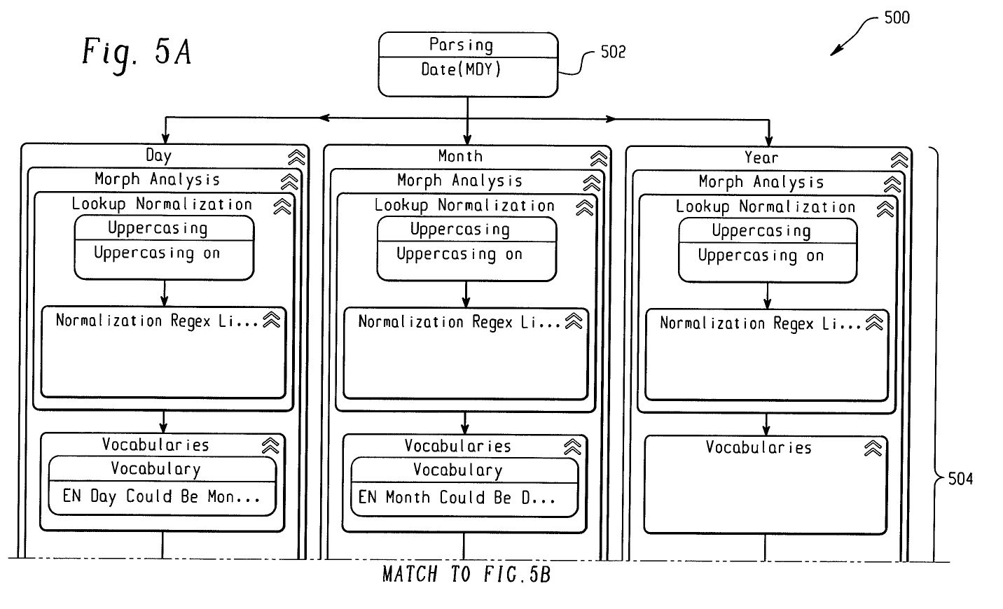

FIG. 4 illustrates the application 400 of the example token combination rule of FIG. 3. Two records of personal names 402 are processed. For each record, applying the example token combination rule yields two combinations. One combination keeps the original form of the record and the other combination is generated by swapping the first name and last name tokens. Based on the combinations of each record, two matchcodes are generated for each record at step 404. At step 406, a score is calculated for each matchcode based on the scaled rule weights.

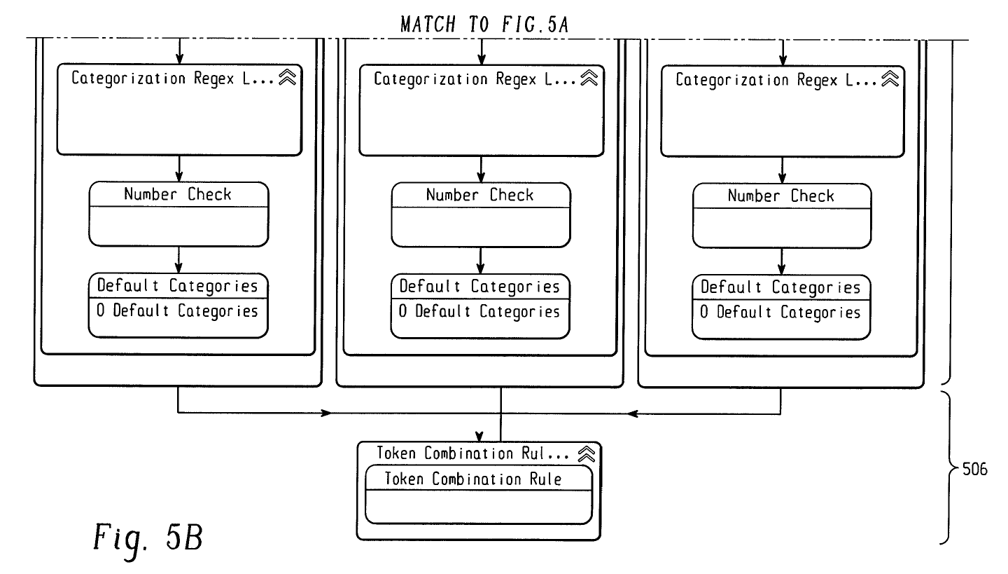

FIGS. 5-7 illustrate an example usage of a token combination rule to address the day/month transposition problem for records of dates. FIG. 5 shows an example process 500 of applying one or more token combination rules to date records. A date record is parsed into the day token, the month token, and the year token at step 502. These tokens are categorized at step 504 with vocabularies used for the day and month tokens. Then at step 506, one or more token combination rules may be applied to the tokens. The different combinations of tokens arising from the application of the token combination rules then pass to further string manipulation blocks (not shown) for generation of matchcodes.

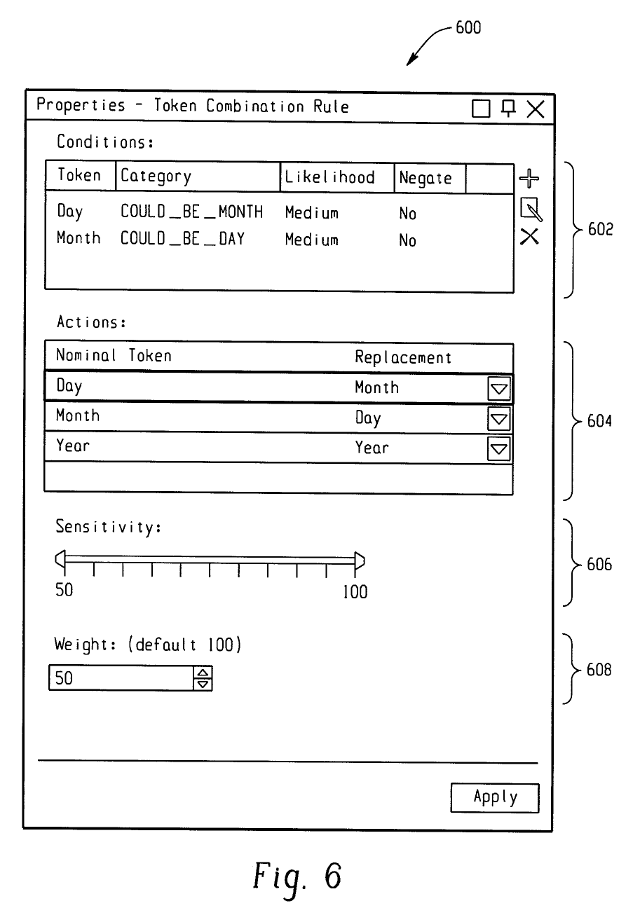

FIG. 6 shows a screen shot 600 of the configuration of an example token combination rule for date records. The rule contains conditions 602, actions 604, a sensitivity range 606, and a rule weight 608. As shown at step 602, the day token of a date record is assigned to a category COULD_BE MONTH with a likelihood of “medium.” The month token of the date record is assigned to a category COULD_BE_DAY with a likelihood of “medium.” The negate option is specified “no” which indicates that the negation logic is not to be applied. The day and month tokens can be transposed only when both the day and month are given as numbers, and the numbers lie between 1 and 12 (inclusive). These conditions are set up using vocabularies (dictionaries) on the month and day tokens. The actions of the rule 604 are described by swapping the day and month tokens. The sensitivity range 606 controls whether the rule is evaluated for the sensitivity level at which matchcodes are generated. The rule weight 608 is set to 50 with the assumption that the no-rule weight is 100.

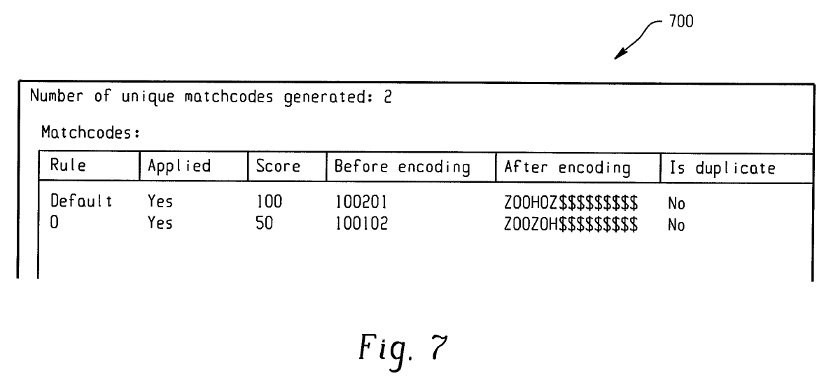

FIG. 7 shows a screenshot 700 of matchcodes generated with the application of the token combination rule shown in FIG. 6 on a date record of “Feb. 1, 2010.” Two matchcodes are generated after the application of the token combination rule and the matchcodes' texts appear in the YYMMDD form.

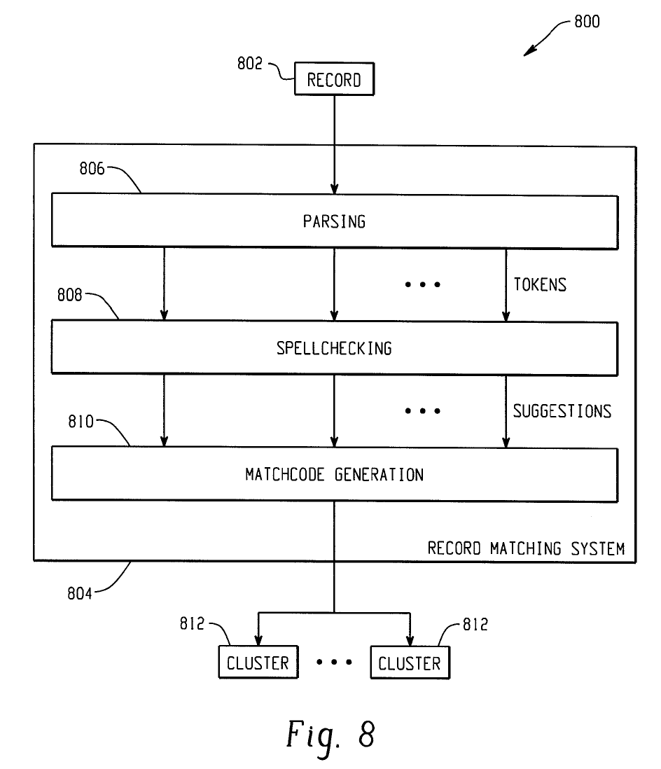

FIG. 8 shows an example system 800 for matching a record to one or more record clusters based on spellchecking. The example system 800 includes a record matching system 804 for processing a record 802 based on spellchecking to address possible spelling errors within tokens. Another source of ambiguity in record matching is spelling errors within a token. The spelling errors may include data entry errors, orthographic variants, homophones, etc. Some examples are shown in Table 3.

TABLE 3
Some examples of spelling errors

| Source of error | Example |
|---|---|
| Mistyping - deletion | George, Gerge |
| Mistyping - insertion | George, Geoorge |
| Mistyping - replacement | George, Geprge |
| Mistyping - transposition | George, Goerge |
| Orthographic variant | Evonne, Yvonne |
| Homophone | Li, Leigh |
| Mis-hearing | Eliza, Elijah |
| Rendering unfamiliar word “as heard” | Phoebe, Feebe |
| Illegible handwriting or poor optical character | Erin, Enn |
| recognition (OCR) | |

The record 802 is parsed into one or more tokens at step 806, if the record is not already divided into tokens. At step 808, spellchecking is applied to the tokens of the record through the usage of spellcheckers. A token may have its own spellchecker. Dictionaries used by a spellchecker may be specialized to the type of data expected for that spellchecker's token. The notion of correctness may be domain-specific.

A spellchecker generates suggestions for a token to address possible spelling errors. For example, for the last name token of a personal name record “SCOTT JAMAS,” a spellchecker may generate three suggestions—JAMAS, JAMES, and KAMAS. The token itself, without correction, is kept as a suggestion. This allows for rare terms not found in the spellchecker's dictionaries. Suggestions are required even for words that appear to be correctly spelled because a correctly-spelled word may be an erroneous version of another intended word. In addition to suggestions, a spellchecker may output a score for each suggestion.

Behavior of a spellchecker can be user-configurable. For example, a user may allow certain types of errors to be corrected, but not others. Numeric costs may be attached to different error categories and thresholds may be applied. These user configurable parameters may model the error-environment, and may affect both the contents and the scores of the suggestions.

Matchcodes may be generated at step 810 based on different combinations of the suggested tokens. For example, three suggestions may be generated for the last name token of a personal name record “SCOTT JAMAS”—JAMAS, JAMES, and KAMAS. Three matchcodes may be generated based on combinations of these suggestions—“SCOTT JAMAS,” “SCOTT JAMES,” and “SCOTT KAMAS.” The generated matchcodes are used to compare with a plurality of record clusters. The record is assigned to every record cluster that matches with one matchcode of the record at step 812.

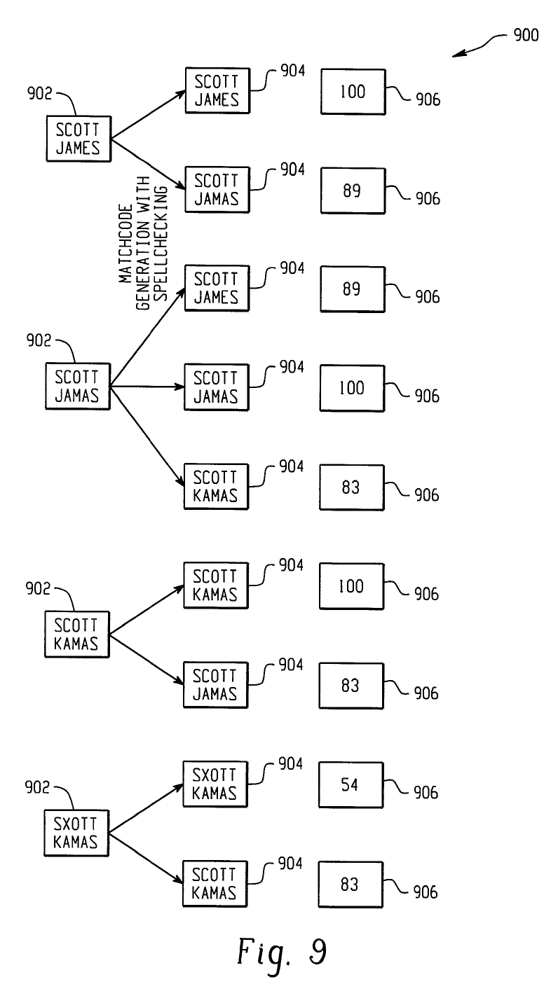

FIG. 9 shows an example 900 of record matching using spellchecking. In the illustrated example 4-record dataset 902 is processed. Matchcodes 904 are generated for the records based on spellchecking. A score 906 is generated for each matchcode based on the user configurable parameters, such as the numerical costs of the errors categories.

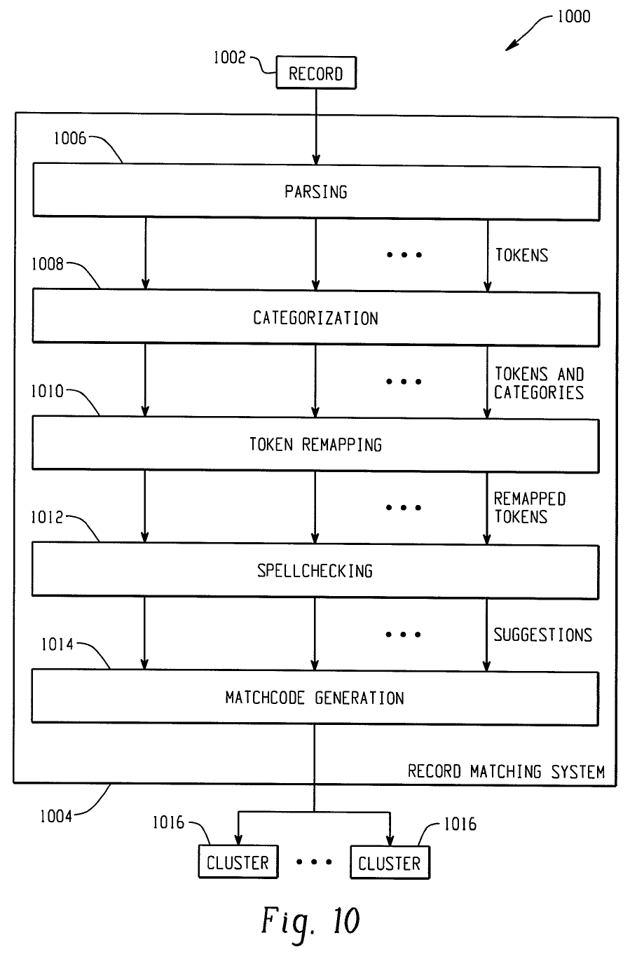

FIG. 10 shows an example system for matching a record to one or more record clusters based on token remapping and spellchecking. The example system 1000 includes a record matching system 1004 for processing a record 1002 based on token remapping and spellchecking to address both the token-level errors and the spelling errors within tokens. The record 1002 is parsed into one or more tokens at step 1006, if the record is not already divided into tokens.

At step 1008, the tokens of the record may be assigned to different categories indicating a likelihood of input errors. A plurality of different combinations of the tokens may be generated (token remapping) at step 1010 to address the possible input errors based on the tokens' assigned categories.

At 1012, spellchecking is carried out on the combinations of remapped tokens. One or more suggestions may be generated for each token to address possible spelling errors. Matchcodes may be generated at step 1014 based on different combinations of the suggestions of the remapped tokens. When there are multiple suggestions for each token under each token combination rule's remapping, the number of possible matchcodes for the record may thus be combinatorial. The generated matchcodes are used to compare with a plurality of record clusters. At step 1016, the record is assigned to every record cluster that matches with one matchcode of the record.

A final score generated for each matchcode may be based on the weights of the token combination rules and the user configurable parameters of the spellcheckers, such as numerical costs of the spelling error categories. The weight assigned to each token combination rule, as well as the allowed errors and the cost of each type of error in the spellchecker, may be assigned or updated in one or a combination of several ways:

(1) by applying ad hoc, qualitative knowledge of the error environment (e.g. from surveys of data entry operators);

(2) by performing a manual exercise in which a subject-area expert tags a data sample, indicating which rules or spelling errors may be applicable to each record, and determining the “correct” clustering (which is used as a target for optimizing the weights and costs); or

(3) via some sort of long-term, automated feedback/optimization process that continuously updates the weights/costs over time, utilizing the user's actual cluster resolutions (i.e. the final decisions on which cluster each record actually does belong to) as the optimization goal.

Scores of matchcodes may be used to aid cluster resolution, i.e. to determine whether some or all of the records in a cluster should be replaced by a canonical record, and what the contents of that canonical record should be. This resolution process may be manual (i.e. by user inspection and editing of the clusters) or automated, perhaps making use of user-configurable cluster resolution rules.

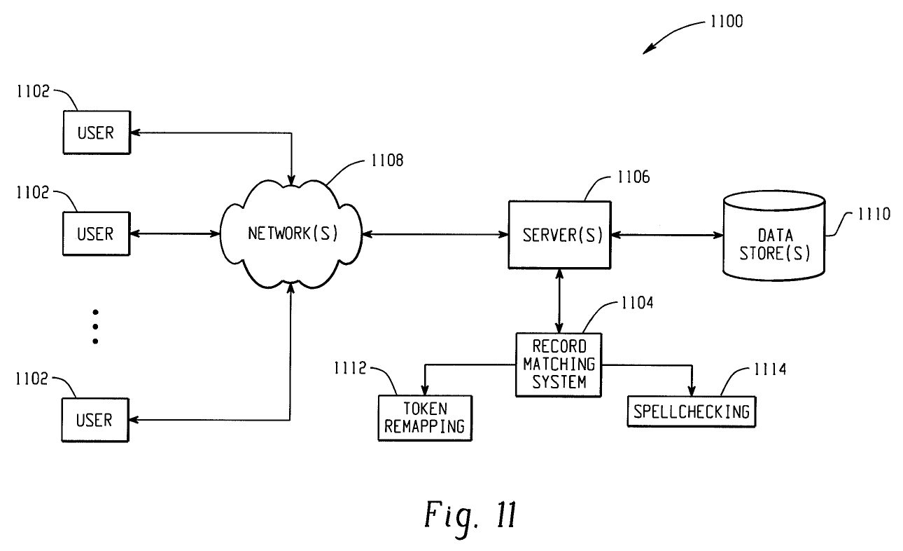

FIG. 11 shows a computer-implemented environment wherein users 1102 can interact with a record matching system 1104 hosted on one or more servers 1106 through a network 1108. The record matching system 1104 can match a record to one or more record clusters. Two approaches may be implemented, individually or in combination, in the record matching system, token-remapping 1112 and spellchecking 1114.

The users 1102 can interact with the system 1104 through a number of ways, such as over one or more networks 1108. One or more servers 1106 accessible through the network(s) 1108 can host the record-cluster matching system 1104. The one or more servers 1106 are responsive to one or more data stores 1110 for providing input data to the record matching system 1104.

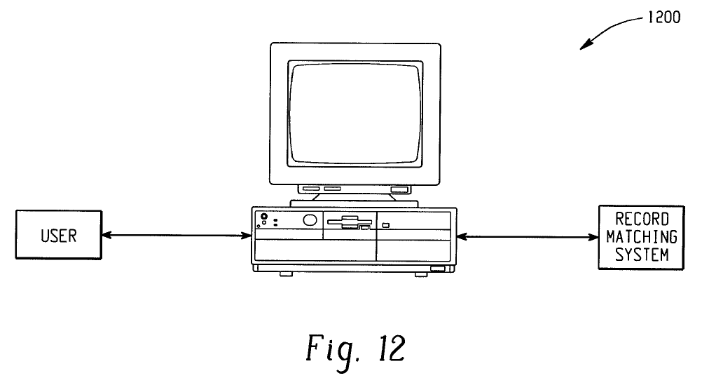

This written description uses examples to disclose the invention, including the best mode, and also to enable a person skilled in the art to make and use the invention. The patentable scope of the invention may include other examples. As an example, a computer-implemented system and method can be configured as described herein to handle the ambiguity inherent in a record matching problem by allowing a record to potentially be assigned to more than one record cluster. As another example, a computer-implemented system and method can be configured to provide a resource-saving approach to matching records in a data set. Such an approach uses computational resources on the order of N, the number of records in the data set, better than the general-purpose clustering methods, which depend on the computation of some concept of distance between records and thus require resources on the order of N². As another example, a computer-implemented system and method can be configured such that a record matching system can be provided on a stand-alone computer for access by a user, such as shown at 1200 in FIG. 12.

As another example, the systems and methods may include data signals conveyed via networks (e.g., local area network, wide area network, interne, combinations thereof, etc.), fiber optic medium, carrier waves, wireless networks, etc. for communication with one or more data processing devices. The data signals can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand. It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

We claim:

1. A computer-implemented method for assigning a record to one or more record clusters, comprising:
receiving a record that includes a plurality of fields;
identifying a field in the record that has a likelihood of including an input error;
generating one or more alternative fields with alternative inputs;
comparing the identified field and the one or more alternative fields with a plurality of record clusters to identify a cluster with a matching field; and
assigning the record to the identified cluster based at least in part on the matching field;
wherein the steps of the method are performed by software instructions stored in one or more computer-readable media and executable by one or more processors.

2. The method of claim 1, wherein an input error is one of the following: an omission of inputs, a mistyping, an orthographic variant, a homophone, a mis-hearing, a rendering of an unfamiliar word as heard, illegible handwriting, and an optical character recognition error.

3. The method of claim 2, wherein an alternative field is generated with a blank string when the input error is an omission of inputs.

4. The method of claim 1, further comprising:
generating a matchcode based on each of the identified field and the one or more alternative fields, wherein the matchcodes are compared with the plurality of record clusters to identify the cluster with a matching field.

5. The method of claim 4, further comprising:
assigning a cost to each of the identified field and the one or more alternative fields; and
determining a score for each matchcode based on the cost of the field upon which the matchcode is generated.

6. The method of claim 1, wherein a field is one of a first name, a last name, a day, a month, a year, or a part of an address.

7. A computer-implemented method for assigning a record to one or more record clusters, comprising:
receiving a record that includes a plurality of fields;
identifying two or more fields in the record that have a likelihood of being transposed;
generating combinations of the two or more identified fields;
comparing the combinations with a plurality of record clusters to identify a cluster with a matching combination; and
assigning the record to the identified cluster based at least in part on the matching combination;
wherein the steps of the method are performed by software instructions stored in one or more computer-readable media and executable by one or more processors.

8. The method of claim 7, further comprising:
generating a matchcode for each of the combinations, wherein the matchcodes are compared with the plurality of record clusters to identify the cluster with a matching combination.

9. The method of claim 7, wherein a combination is created by swapping two fields in the record that have a likelihood of being transposed.

10. The method of claim 7, wherein the combinations are created based on one or more input error correction rules that each comprises one or more conditions;
wherein when all conditions of an error correction rule are satisfied, the error correction rule applies to the record for creating a combination of the two or more identified fields;
wherein each error correction rule has a rule weight that reflects the importance of the error correction rule, relative to other error correction rules.

11. The method of claim 10, further comprising:
determining a score for each matchcode corresponding to a combination based on the rule weight of the input error correction rule that is applied to the record to create the combination.

12. The method of claim 10, wherein identifying two or more fields in the record that have a likelihood of being transposed comprises:
assigning the two or more fields to categories which indicate a likelihood of being transposed.

13. The method of claim 10, wherein an input error correction rule is a default rule that means applying no rule to the record.

14. The method of claim 7, further comprising:
for each combination, identifying a field in the combination that has a likelihood of including a spelling error;
generating one or more alternative fields with alternative spellings;
comparing the identified field and the one or more alternative fields with a plurality of record clusters to identify a cluster with a matching field; and
assigning the record to the identified cluster based at least in part on the matching field.

15. The method of claim 14, wherein a spelling error is one of the following: a mistyping, an orthographic variant, a homophone, a mis-hearing, a rendering of an unfamiliar word as heard, illegible handwriting, and an optical character recognition error.

16. The method of claim 14, further comprising:
generating a matchcode based on each of the identified field and the one or more alternative fields, wherein the matchcodes are compared with the plurality of record clusters to identify the cluster with a matching field.

17. A computer-implemented system for assigning a record to one or more clusters, said system comprising:
one or more data processors;
a computer-readable memory encoded with instructions for commanding the one or more data processors to perform steps comprising:
receiving a record that includes a plurality of fields;
identifying a field in the record that has a likelihood of including an input error;
generating one or more alternative fields with alternative inputs;
comparing the identified field and the one or more alternative fields with a plurality of record clusters to identify a cluster with a matching field; and
assigning the record to the identified cluster based at least in part on the matching field.

18. The system of claim 17, wherein the instructions encoded in the computer-readable memory can command the one or more data processors to perform further steps comprising:
generating a matchcode based on each of the identified field and the one or more alternative fields, wherein the matchcodes are compared with the plurality of record clusters to identify the cluster with a matching field.

19. A computer-implemented system for assigning a record to one or more clusters, said system comprising:
one or more data processors;
a computer-readable memory encoded with instructions for commanding the one or more data processors to perform steps comprising:
receiving a record that includes a plurality of fields;
identifying two or more fields in the record that have a likelihood of being transposed;
creating combinations of the two or more identified fields;
comparing the combinations with a plurality of record clusters to identify a cluster with a matching combination; and
assigning the record to the identified cluster based at least in part on the matching combination.

20. The system of claim 19, wherein the instructions encoded in the computer-readable memory can command the one or more data processors to perform further steps comprising:
generating a matchcode for each of the combinations, wherein the matchcodes are compared with the plurality of record clusters to identify the cluster with a matching combination.

21. The system of claim 19, wherein the instructions encoded in the computer-readable memory can command the one or more data processors to perform further steps comprising:
for each combination, identifying a field in the combination that has a likelihood of including a spelling error;
generating one or more alternative fields with alternative spellings;
comparing the identified field and the one or more alternative fields with a plurality of record clusters to identify a cluster with a matching field; and
assigning the record to the identified cluster based at least in part on the matching field.
